(19) United States
(12) Patent Application Publication
(10) Pub. No.: US 2023/0246172 A1
(43) Pub. Date: Aug. 3, 2023

(54) LITHIATION ADDITIVE FOR SOLID-STATE BATTERY INCLUDING GEL ELECTROLYTE

(71) Applicant: GM GLOBAL TECHNOLOGY OPERATIONS LLC, Detroit, MI (US)

(72) Inventors: Zhe LI, Shanghai (CN); Qili SU, Shanghai (CN); Yong LU, Shanghai (CN); Meiyuan WU, Shanghai (CN); Haijing LIU, Shanghai (CN)

(73) Assignee: GM GLOBAL TECHNOLOGY OPERATIONS LLC, Detroit, MI (US)

(21) Appl. No.: 17/746,575

(22) Filed: May 17, 2022

(30) Foreign Application Priority Data
Jan. 29, 2022 (CN) 202210111107.8

(51) Int. Cl. H01M 4/36; H01M 4/62; H01M 10/0565; H01M 4/58; H01M 10/0525

(52) U.S. Cl. CPC H01M 4/366; H01M 4/62; H01M 10/0565; H01M 4/5815; H01M 10/0525; H01M 2004/028

(57) ABSTRACT

A positive electrode including an active layer is provided, where the active layer includes a plurality of positive electroactive solid-state particles, a lithium-source material coated on or dispersed with the positive electroactive solid-state particles in the active layer, and a polymeric gel electrolyte at least partially filling voids between the positive electroactive solid-state particles in the active layer. The lithium-source material having a theoretical specific capacity greater than or equal to about 100 mAh/g to less than or equal to about 3,000 mAh/g.

### CROSS-REFERENCE TO RELATED APPLICATIONS

This application claims the benefit of Chinese Patent Application No. 202210111107.8, filed Jan. 29, 2022. The entire disclosure of the above application is incorporated herein by reference.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“pVBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. A separator and/or electrolyte may be disposed between the negative and positive electrodes. The electrolyte is suitable for conducting lithium ions between the electrodes and, like the two electrodes, may be in in a solid form, a liquid form, or a solid-liquid hybrid form. In instances of solid-state and semi-solid batteries, which include solid-state and/or semi-solid electrodes and solid-state and/or semi-solid electrolytes, the solid-state or semi-solid electrolyte may physically separate the electrodes so that a distinct separator is not required.

Rechargeable lithium-ion batteries operate by reversibly passing lithium ions back and forth between the negative electrode and the positive electrode. For example, lithium ions may move from the positive electrode to the negative electrode during charging of the battery, and in the opposite direction when discharging the battery. Such lithium-ion batteries can reversibly supply power to an associated load device on demand. More specifically, electrical power can be supplied to a load device by the lithium-ion battery until the lithium content of the negative electrode is effectively depleted. The battery may then be recharged by passing a suitable direct electrical current in the opposite direction between the electrodes.

During discharge, the negative electrode may contain a comparatively high concentration of intercalated lithium, which is oxidized into lithium ions releasing electrons. Lithium ions may travel from the negative electrode to the positive electrode, for example, through the semi-solid or solid-state electrolyte. Concurrently, electrons pass through an external circuit from the negative electrode to the positive electrode. Such lithium ions may be assimilated into the material of the positive electrode by an electrochemical reduction reaction. The battery may be recharged or regenerated after a partial or full discharge of its available capacity by an external power source, which reverses the electrochemical reactions that transpired during discharge. In various instances, however, a portion of the lithium ions remains with the negative electrode following the first cycle due to, for example, conversion reactions and/or the formation of a solid electrolyte interphase (SEI) layer on the negative electrode during the first cycle, as well as ongoing lithium loss due to, for example, continuous solid electrolyte interphase growth. Such permanent loss of lithium ions may result in a decreased specific energy and power of the battery. Accordingly, it would be desirable to develop improved electrodes, and methods of making and using the same, that can address these challenges.

### SUMMARY

This section provides a general summary of the disclosure, and is not a comprehensive disclosure of its full scope or all of its features.

The present disclosure relates to solid-state batteries including a polymeric gel electrolyte system and a lithium-source material, and to methods for forming the same.

In various aspects, the present disclosure provides a positive electrode including an active layer. The active layer may include a plurality of positive electroactive solid-state particles, a lithium-source material coated on or dispersed with the positive electroactive solid-state particles in the active layer, and a polymeric gel electrolyte at least partially filling voids between the positive electroactive solid-state particles in the active layer. The lithium-source material may have a theoretical specific capacity greater than or equal to about 100 mAh/g to less than or equal to about 3,000 mAh/g.

In one aspect, the lithium-source material may include lithium sulfide (Li₂S).

In one aspect, the lithium-source material may be selected from the group consisting of: lithium sulfide (Li₂S), 3,4-dihydroxybenzonitrile dilithium salt (Li₂DHBN), LiN₃, Li₃N, Li_{0.65}Ni_{1.35}O₂, Li₅FeO₄, Li₅ReO₆, Li₆CoO₄, Li₃V₂(PO₄)₃, lithium fluoride (LiF), Li₂O, Li₂S/Co, Li₂CuO₂, Li₂NiO₂, Li₂MoO₃, and combinations thereof.

In one aspect, the positive electrode may include greater than or equal to about 0.01 wt. % to less than or equal to about 50 wt. % of the lithium-source material.

In one aspect, the lithium-source material may be coated on the positive electroactive solid-state particles. For example, the lithium-source material may cover greater than or equal to about 5 vol. % to less than or equal to about 100 vol. % of a total exposed surface area of at least one positive electroactive solid-state particle of the plurality of positive electroactive solid-state particles.

In one aspect, the lithium-source material coating may have an average thickness of greater than or equal to about 1 nm to less than or equal to about 500 nm.

In one aspect, the lithium-source material may define a plurality of lithium-source particles that are dispersed with the positive electroactive solid-state particles in the active layer.

In one aspect, the lithium-source particles may have an average particle size greater than or equal to about 20 nm to less than or equal to about 20 μm.

In one aspect, the polymeric gel electrolyte may include greater than or equal to about 0.1 wt. % to less than or equal to about 50 wt. % of a polymeric host. The polymeric host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof. The polymeric gel electrolyte may further include greater than or equal to about 5 wt. % to less than or equal to about 90 wt. % of a liquid electrolyte. The liquid electrolyte may include at least one anion selected from the group consisting of: hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI) bis(pentafluoroethanesulfonyl)imide (BETI), bis(oxalate)borate (BOB), difluoro(ocalato)borate (DFOB), bis(fluoromalonato)boarate (BFMB), and combinations thereof.

In one aspect, the positive electrode may further include a plurality of solid-state electrolyte particles dispersed with the positive electroactive solid-state particles.

In various aspects, the present disclosure provides an electrochemical cell that cycles lithium ions. The electrochemical cell may include an electrode. The electrode may include a plurality of electroactive solid-state particles, a lithium-source material coated on or dispersed with the electroactive solid-state particles in the electrode, and a polymeric gel electrolyte at least partially filling voids between the electroactive solid-state particles. The lithium-source material may have a theoretical specific capacity greater than or equal to about 100 mAh/g to less than or equal to about 3,000 mAh/g.

In one aspect, the lithium-source material may be selected from the group consisting of: lithium sulfide (Li₂S), 3,4-dihydroxybenzonitrile dilithium salt (Li₂DHBN), LiN₃, Li₃N, Li_{0.65}Ni_{1.35}O₂, Li₅FeO₄, Li₅ReO₆, Li₆CoO₄, Li₃V₂(PO₄)₃, lithium fluoride (LiF), Li₂O, Li₂S/Co, Li₂CuO₂, Li₂NiO₂, Li₂MoO₃, and combinations thereof.

In one aspect, the electrode may include greater than or equal to about 0.01 wt. % to less than or equal to about 50 wt. % of the lithium-source material.

In one aspect, the lithium-source material may be coated on the electroactive solid-state particles. For example, the lithium-source material may cover greater than or equal to about 5 vol. % to less than or equal to about 100 vol. % of a total exposed surface area of at least one electroactive solid-state particle of the plurality of electroactive solid-state particles. The lithium-source material coating may have an average thickness of greater than or equal to about 1 nm to less than or equal to about 500 nm.

In one aspect, the lithium-source material may define a plurality of lithium-source particles that are dispersed with the electroactive solid-state particles. The lithium-source particles may have an average particle size greater than or equal to about 20 nm to less than or equal to about 20 μm.

In one aspect, the electrode may be a first electrode, the plurality of electroactive solid-state particles may be a plurality of first electroactive solid-state particles, and the polymeric gel electrolyte may be a first polymeric gel electrolyte. In such instances, the electrochemical cell may further include a second electrode and an electrolyte layer disposed between the first electrode and the second electrode. The second electrode may include a plurality of second electroactive solid-state particles and a second polymeric gel electrolyte. The electrolyte layer may include a third polymeric gel electrolyte.

In one aspect, the first polymeric gel electrolyte, the second polymeric gel electrolyte, and the third polymeric gel electrolyte each includes a polymeric host independently selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof; a lithium salt including at least one anion independently selected from hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI) bis(pentafluoroethanesulfonyl)imide (BETI), bis(oxalate)borate (BOB), difluoro(ocalato)borate (DFOB), bis(fluoromalonato)boarate (BFMB), and combinations thereof; and a solvent independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), δ-valerolactone, succinonitrile, glutaronitrile, adiponitrile, tetramethylene sulfone, ethyl methyl sulfone, vinyl sulfone, phenyl sulfone, 4 fluorophenyl sulfone, benzyl sulfone, triethylene glycol dimethylether (triglyme, G3), tetraethylene glycol dimethylether (tetraglyme, G4), 1,3-dimethyoxy propane, 1,4-dioxane, triethyl phosphate, trimethyl phosphate, 1-ethyl-3-methylimidazolium ([Emim]+), 1-propyl-1-methylpiperidinium ([PP13]+), 1-butyl-1-methylpiperidinium ([PP14]+), 1-methyl-1-ethylpyrrolidinium ([Pyr12]+), 1-propyl-1-methylpyrrolidinium ([Pyr13]+), 1-butyl-1-methylpyrrolidinium ([Pyr14]+), bis(trifluoromethanesulfonyl)imide (TFSI), bis(fluorosulfonyl imide (FS), and combinations thereof.

In one aspect, the electrolyte layer further includes a plurality of solid-state electrolyte particles.

In one aspect, the electrolyte layer may be a free-standing membrane.

In various aspects, the present disclosure provides a positive electrode that includes a plurality of positive electroactive solid-state particles, a lithium-source material coated on at least one positive electroactive solid-state particle of the plurality of positive electroactive solid-state particles, and a polymeric gel electrolyte at least partially filling voids between the positive electroactive solid-state particles. The lithium-source material may include a lithium sulfide (Li₂S). The lithium-source material may cover greater than or equal to about 5 vol. % to less than or equal to about 100 vol. % of a total exposed surface area of the at least one positive electroactive solid-state.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is an illustration of an example solid-state battery in accordance with various aspects of the present disclosure;

FIG. 1B is an example solid-state battery having a polymeric gel electrolyte system in accordance with various aspects of the present disclosure;

FIG. 1C is an example solid-state battery having a polymeric gel electrolyte system and a lithium-source material in accordance with various aspects of the present disclosure;

FIG. 2 is another example solid-state battery having a polymeric gel electrolyte system and lithium-source material in accordance with various aspects of the present disclosure;

FIG. 3 is yet another example solid-state battery having a polymeric gel electrolyte system and lithium-source material in accordance with various aspects of the present disclosure;

FIG. 4 is an example method for forming a first electrode including a polymeric gel electrolyte system and a lithium-source material in accordance with various aspects of the present disclosure;

FIG. 5A is a graphical illustration demonstrating electrochemical performance of example battery cells prepared in accordance with various aspects of the present disclosure

FIG. 5B is another graphical illustration demonstrating electrochemical performance of example battery cells prepared in accordance with various aspects of the present disclosure;

FIG. 5C is still another graphical illustration demonstrating electrochemical performance of example battery cells prepared in accordance with various aspects of the present disclosure; and

FIG. 5D is yet another graphical illustration demonstrating electrochemical performance of example battery cells prepared in accordance with various aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs) and methods of forming and using the same. Solid-state batteries may include at least one solid component, for example, at least one solid electrode, but may also include, in certain variations, semi-solid or gel, liquid, or gas components. In various instances, solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, cathode material particles. The second mixture may include, as solid-state electroactive material particles, anode material particles. The solid-state electrolyte particles in each instance may be the same or different.

In other variations, the solid-state batteries may have a monopolar stacking design comprising a plurality of monopolar electrodes where a first mixture of solid-state electroactive material particles (and optional solid-state electrolyte particles) is disposed on both a first side and a second side of a first current collector, wherein the first and second sides of the first current collector are substantially parallel, and a second mixture of solid-state electroactive material particles (and optional solid-state electrolyte particles) is disposed on both a first side and a second side of a second current collector, where the first and second sides of the second current collector are substantially parallel. The first mixture may include, as the solid-state electroactive material particles, cathode material particles. The second mixture may include, as solid-state electroactive material particles, anode material particles. The solid-state electrolyte particles in each instance may be the same or different. In certain variations, solid-state batteries may include a mixture of combination of bipolar and monopolar stacking designs.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

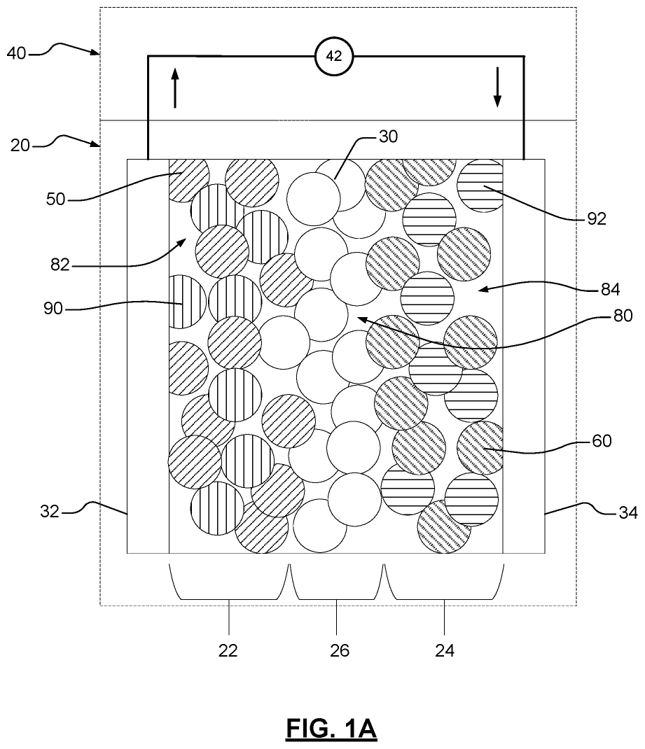

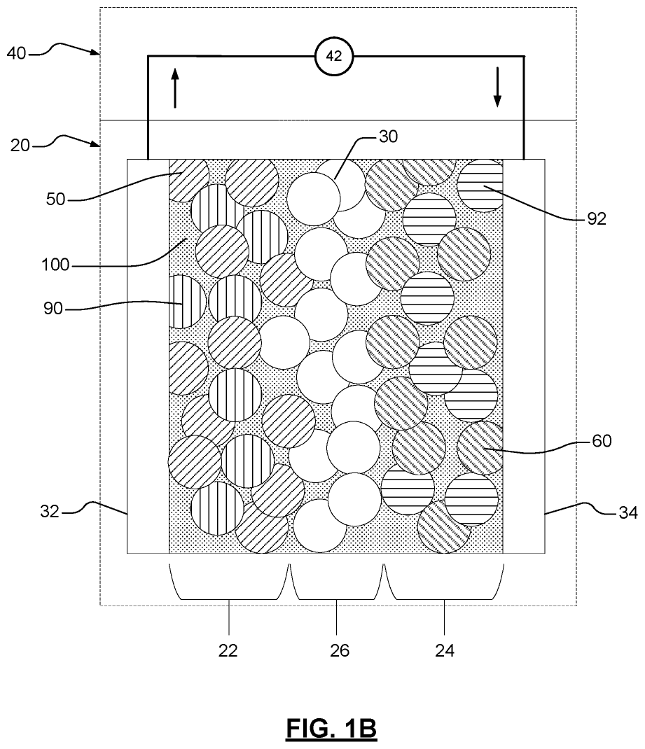

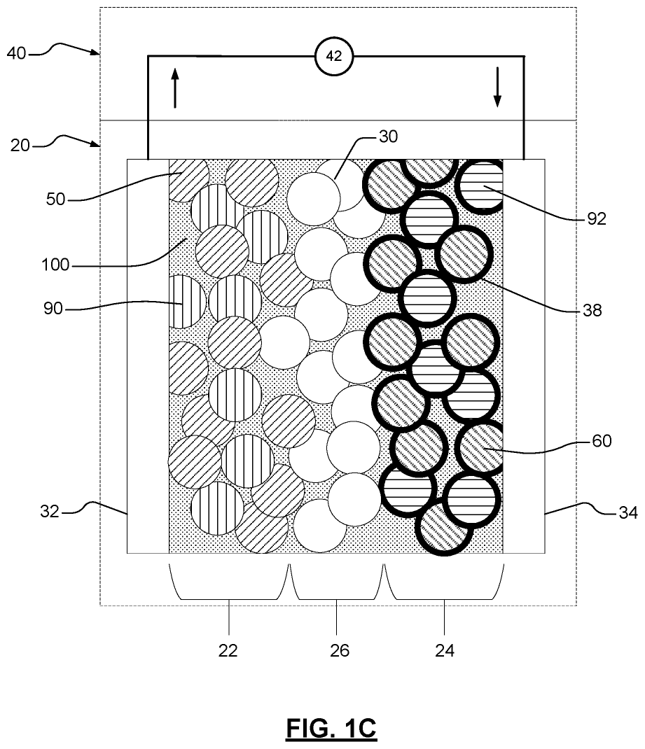

An exemplary and schematic illustration of a solid-state electrochemical cell unit (also referred to as a “solid-state battery” and/or “semi-solid battery” and/or “semi-solid electrochemical cell unit” and/or “battery”) 20 that cycles lithium ions is shown in FIGS. 1A and 1B. The battery 20 includes a negative electrode (i.e., anode) 22, a positive electrode (i.e., cathode) 24, and an electrolyte layer 26 that occupies a space between the two or more electrodes. The electrolyte layer 26 may be a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network. The second plurality of solid-state electrolyte particles 90 may be the same as or different from the first plurality of solid-state electrolyte particles 30, and the third plurality of solid-state electrolyte particles 92 may be the same as or different from the second plurality of solid-state electrolyte particles 90.

A first current collector 32 may be positioned at or near the negative electrode 22. The first current collector 32 may be a metal foil, metal grid or screen, or expanded metal comprising copper or any other appropriate electrically conductive material known to those of skill in the art. A second current collector 34 may be positioned at or near the positive electrode 24. The second current collector 34 may be a metal foil, metal grid or screen, or expanded metal comprising aluminum or any other appropriate electrically conductive material known to those of skill in the art. The first current collector 32 and the second current collector 34 may be the same or different. The first current collector 32 and the second electrode current collector 34 respectively collect and move free electrons to and from an external circuit 40. For example, an interruptible external circuit 40 and a load device 42 may connect the negative electrode 22 (through the first current collector 32) and the positive electrode 24 (through the second current collector 34).

Although not illustrated, the skilled artisan will recognize that in certain variations, the first current collector 32 may be a first bipolar current collector and/or the second current collector 34 may be a second bipolar current collector. For example, the first bipolar current collector 34 and/or the second bipolar current collector 34 may be a cladded foil, for example, where one side (e.g., the first side or the second side) of the current collector 32, 34 includes one metal (e.g., first metal) and another side (e.g., the other side of the first side or the second side) of the current collector 32 includes another metal (e.g., second metal). The cladded foil may include, for example only, aluminum-copper (Al—Cu), nickel-copper (Ni—Cu), stainless steel-copper (SS-Cu), aluminum-nickel (Al—Ni), aluminum-stainless steel (Al-SS), and nickel-stainless steel (Ni-SS). In certain variations, the first bipolar current collector 32 and/or second bipolar current collectors 34 may be pre-coated, such as graphene or carbon-coated aluminum current collectors.

The battery 20 can generate an electric current (indicated by arrows in FIGS. 1A and 1B) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 toward the positive electrode 24. Lithium ions, which are also produced at the negative electrode 22, are concurrently transferred through the electrolyte layer 26 toward the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the electrolyte layer 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the electrolyte layer 26.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIGS. 1A and 1B, the electrolyte layer 26, which may be a semi-solid, provides electrical separation-preventing physical contact-between the negative electrode 22 and the positive electrode 24. The electrolyte layer 26 also provides a minimal resistance path for internal passage of ions. In various aspects, the electrolyte layer 26 may be defined by a first plurality of solid-state electrolyte particles 30. For example, the electrolyte layer 26 may be in the form of a layer or a composite that comprises the first plurality of solid-state electrolyte particles 30.

In certain variations, the electrolyte layer 26 may be in the form of a layer having a thickness greater than or equal to about 1 μm to less than or equal to about 1,000 μm, optionally greater than or equal to about 5 μm to less than or equal to about 200 μm, optionally greater than or equal to about 10 μm to less than or equal to about 100 μm, optionally about 20 μm, and in certain aspects, optionally about 15 μm. The electrolyte layer 26 may be in the form of a layer having a thickness greater than or equal to 1 μm to less than or equal to 1,000 μm, optionally greater than or equal to 5 μm to less than or equal to 200 μm, optionally greater than or equal to 10 μm to less than or equal to 100 μm, optionally 20 μm, and in certain aspects, optionally 15 μm.

As illustrated in FIG. 1A, the electrolyte layer 26 may have an interparticle porosity 80 between the solid-state electrolyte particles 30 that is greater than 0 vol. % to less than or equal to about 50 vol. %, optionally greater than or equal to about 1 vol. % to less than or equal to about 40 vol. %, and in certain aspects, optionally greater than or equal to about 2 vol. % to less than or equal to about 20 vol. %. The electrolyte layer 26 may have an interparticle porosity 80 between the solid-state electrolyte particles 30 that is greater than 0 vol. % to less than or equal to 50 vol. %, optionally greater than or equal to 1 vol. % to less than or equal to 40 vol. %, and in certain aspects, optionally greater than or equal to 2 vol. % to less than or equal to 20 vol. %.

In certain variations, the solid-state electrolyte particles 30 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 5 μm. The solid-state electrolyte particles 30 may have an average particle diameter greater than or equal to 0.02 μm to less than or equal to 20 μm, optionally greater than or equal to 0.1 μm to less than or equal to 10 μm, and in certain aspects, optionally greater than or equal to 0.1 μm to less than or equal to 5 μm. For example, the solid-state electrolyte particles 30 may comprise one or more sulfide-based particles, oxide-based particles, metal-doped or aliovalent-substituted oxide particles, inactive oxide particles, nitride-based particles, hydride-based particles, halide-based particles, and borate-based particles.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI·0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}C_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃+ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P3O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the inactive oxide particles may include, for example only, SiO₂, Al₂O₃, TiO₂, ZrO₂, and combinations thereof; the nitride-based particles may include, for example only, Li₃N, Li₇PN₄, LiSi₂N₃, and combinations thereof; the hydride-based particles may include, for example only, LiBH₄, LiBH₄—LiX (where X=Cl, Br, or I), LiNH₂, Li₂NH, LiBH₄—LiNH₂, Li₃AlH₆, and combinations thereof; the halide-based particles may include, for example only, LiI, Li₃InCl, Li₂CdCl₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄(thio-LISICON), Li₁₀SnP₂S₁₂, Li₁₀SiP₂S₁₂, Li_{9.54}Si_{1.74}P_{1.44}S_{1.7}Cl_{0.3}, (1−x)P₂S₅₋ₓLi₂S (where 0.5≤x≤0.7), Li_{3.4}Si_{0.4}P_{0.6}S₄, PLi₁₀GeP₂S11.7O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(S_{10.5}Ge_{0.5})P₂S₁₂, Li₁₀(Ge_{0.5}Sn_{0.5})P₂S₁₂, Li₁₀(S_{10.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃+ₓGeₓV₁₋ₓO₄ (where 0<x<1), LiMM′(PO₄)₃(where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃₀₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdCl₄, Li₂MgCl₄, LiCdI₄, Li₂ZnI₄, Li₃OCl, Li₂B₄O₇, Li₂O—B₂O₃—P₂O₅, and combinations thereof.

Although not illustrated, the skilled artisan will recognize that in certain instances, one or more binder particles may be mixed with the solid-state electrolyte particles 30. For example, in certain aspects, the electrolyte layer 26 may include greater than or equal to 0 wt. % to less than or equal to about 10 wt. %, and in certain aspects, optionally greater than or equal to about 0.5 wt. % to less than or equal to about 10 wt. %, of the one or more binders. The electrolyte layer 26 may include greater than or equal to 0 wt. % to less than or equal to 10 wt. %, and in certain aspects, optionally greater than or equal to 0.5 wt. % to less than or equal to 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

The negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. In each variation, the negative electrode 22 may be in the form of a layer having a thickness greater than or equal to about 1 μm to less than or equal to about 1,000 μm, optionally greater than or equal to about 5 μm to less than or equal to about 400 μm, and in certain aspects, optionally greater than or equal to about 10 μm to less than or equal to about 300 μm. The negative electrode 22 may be in the form of a layer having a thickness greater than or equal to 1 μm to less than or equal to 1,000 μm, optionally greater than or equal to 5 μm to less than or equal to 400 μm, and in certain aspects, optionally greater than or equal to 10 μm to less than or equal to 300 μm.

The negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50, and greater than or equal to 0 wt. % to less than or equal to about 50 wt. %, and in certain aspects, optionally greater than or equal to about 5 wt. % to less than or equal to about 20 wt. %, of the second plurality of solid-state electrolyte particles 90. The negative electrode 22 may include greater than or equal to 30 wt. % to less than or equal to 98 wt. %, and in certain aspects, optionally greater than or equal to 50 wt. % to less than or equal to 95 wt. %, of the negative solid-state electroactive particles 50, and greater than or equal to 0 wt. % to less than or equal to 50 wt. %, and in certain aspects, optionally greater than or equal to 5 wt. % to less than or equal to 20 wt. %, of the second plurality of solid-state electrolyte particles 90. The second plurality of solid-state electrolyte particles 90 may be the same as or different from the first plurality of solid-state electrolyte particles 30.

The negative solid-state electroactive particles 50 may be lithium-based, for example, a lithium alloy or lithium metal. In other variations, the negative solid-state electroactive particles 50 may be silicon-based comprising, for example, a silicon alloy and/or silicon-graphite mixture. In still other variations, the negative electrode 22 may be a carbonaceous anode and the negative solid-state electroactive particles 50 may comprise one or more negative electroactive materials, such as graphite, graphene, hard carbon, soft carbon, and carbon nanotubes (CNTs). In still further variations, the negative electrode 22 may comprise one or more negative electroactive materials, such as lithium titanium oxide (Li₄TisO₁₂); one or more metal oxides, such as TiO₂ and/or V₂O₅; metal sulfides, such as FeS; and/or transition-metal electroactive materials, such as tin (Sn). The negative solid-state electroactive particles 50 may be selected from the group including, for example only, lithium, graphite, graphene, hard carbon, soft carbon, carbon nanotubes, silicon, silicon-containing alloys, tin-containing alloys, and/or other lithium-accepting materials.

In certain variations, the negative solid-state electroactive particles 50 may have an average particle diameter greater than or equal to about 0.01 μm to less than or equal to about 50 μm, and in certain aspects, optionally greater than or equal to about 1 μm to less than or equal to about 20 μm. The negative solid-state electroactive particles 50 may have an average particle diameter greater than or equal to 0.01 μm to less than or equal to 50 μm, and in certain aspects, optionally greater than or equal to 1 μm to less than or equal to 20 μm.

Although not illustrated, in certain variations, the negative electrode 22 may include one or more conductive additives and/or binder materials. For example, the negative solid-state electroactive particles 50 (and/or optional second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90 (and/or optional second plurality of solid-state electrolyte particles 90) may be optionally intermingled with binders, such as polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders. The negative electrode 22 may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

In various aspects, the negative electrode 22 may have an interparticle porosity 82 between the negative solid-state electroactive particles 50 and/or the solid-state electrolyte particles 90 (and optionally the one or more conductive additives and/or binder materials) that is greater than or equal to 0 vol. % to less than or equal to about 50 vol. %, and in certain aspects, optionally greater than or equal to about 2 vol. % to less than or equal to about 20 vol. %. The negative electrode 22 may have an interparticle porosity 82 between the negative solid-state electroactive particles 50 and/or the solid-state electrolyte particles 90 that is greater than or equal to 0 vol. % to less than or equal to 50 vol. %, and in certain aspects, optionally greater than or equal to 2 vol. % to less than or equal to 20 vol. %.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. In each variation, the positive electrode 24 may be in the form of a layer having a thickness greater than or equal to about 1 μm to less than or equal to about 1,000 μm, optionally greater than or equal to about 5 μm to less than or equal to about 400 μm, and in certain aspects, optionally greater than or equal to about 10 μm to less than or equal to about 300 μm. The positive electrode 24 may be in the form of a layer having a thickness greater than or equal to 1 μm to less than or equal to 1,000 μm, optionally greater than or equal to 5 μm to less than or equal to 400 μm, and in certain aspects, optionally greater than or equal to 10 μm to less than or equal to 300 μm

The positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60, and greater than or equal to 0 wt. % to less than or equal to about 70 wt. %, optionally greater than or equal to 0 wt. % to less than or equal to about 50 wt. %, and in certain aspects, optionally greater than or equal to about 5 wt. % to less than or equal to about 20 wt. %, of the third plurality of solid-state electrolyte particles 92. The positive electrode 24 may include greater than or equal to 30 wt. % to less than or equal to 98 wt. %, and in certain aspects, optionally greater than or equal to 50 wt. % to less than or equal to 95 wt. %, of the positive solid-state electroactive particles 60, and greater than or equal to 0 wt. % to less than or equal to 70 wt. %, optionally greater than or equal to 0 wt. % to less than or equal to 50 wt. %, and in certain aspects, optionally greater than or equal to 5 wt. % to less than or equal to 20 wt. %, of the third plurality of solid-state electrolyte particles 92. The third plurality of solid-state electrolyte particles 92 may be the same as or different from the first and/or second pluralities of solid-state electrolyte particles 30, 90.

In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiN_{10.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive solid-state electroactive particles 60 may have an average particle diameter greater than or equal to about 0.01 μm to less than or equal to about 50 μm, and in certain aspects, optionally greater than or equal to about 1 μm to less than or equal to about 20 μm. The positive solid-state electroactive particles 60 may have an average particle diameter greater than or equal to 0.01 μm to less than or equal to 50 μm, and in certain aspects, optionally greater than or equal to 1 m to less than or equal to 20 μm.

Although not illustrated, in certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), poly(vinylidene fluoride-co-hexafluoropropylene (PVDF-HFP), polytetrafluoroethylene (PTFE), sodium carboxymethyl cellulose (CMC), ethylene propylene diene monomer (EPDM) rubber, nitrile butadiene rubber (NBR), styrene-butadiene rubber (SBR), styrene ethylene butylene styrene copolymers (SEBS), styrene butadiene styrene copolymers (SBS), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as, KETCHEN™ black or DENKA™ black), carbon fibers and nanotubes, graphene (such as, graphene oxide), carbon black (such as, Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to 0 wt. % to less than or equal to about 30 wt. %, and in certain aspects, optionally greater than or equal to about 2 wt. % to less than or equal to about 10 wt. %, of the one or more electrically conductive additives; and greater than or equal to 0 wt. % to less than or equal to about 20 wt. %, and in certain aspects, optionally greater than or equal to about 1 wt. % to less than or equal to about 10 wt. %, of the one or more binders. The positive electrode 24 may include greater than or equal to 0 wt. % to less than or equal to 30 wt. %, and in certain aspects, optionally greater than or equal to 2 wt. % to less than or equal to 10 wt. %, of the one or more electrically conductive additives; and greater than or equal to 0 wt. % to less than or equal to 20 wt. %, and in certain aspects, optionally greater than or equal to 1 wt. % to less than or equal to 10 wt. %, of the one or more binders.

In various aspects, the positive electrode 24 may have an interparticle porosity 84 between the positive solid-state electroactive particles 60 and/or the solid-state electrolyte particles 92 (and optionally the one or more conductive additives and/or binder materials) that is greater than or equal to 0 vol. % to less than or equal to about 50 vol. %, and in certain aspects, optionally greater than or equal to about 2 vol. % to less than or equal to about 20 vol. %. The positive electrode 24 may have an interparticle porosity 84 between the positive solid-state electroactive particles 60 and/or the solid-state electrolyte particles 92 that is greater than or equal to 0 vol. % to less than or equal to 50 vol. %, and in certain aspects, optionally greater than or equal to 2 vol. % to less than or equal to 20 vol. %.

As illustrated in FIG. 1A, direct contact between the solid-state electroactive particles 50, 60 and/or the solid-state electrolyte particles 30, 90, 92 (and/or optionally the one or more conductive additives and/or binder materials) may be much lower than the contact between a liquid electrolyte and solid-state electroactive particles in comparable non-solid-state batteries. For example, as illustrated in FIG. 1A, a battery 20 in green form may have an overall interparticle porosity that is greater than or equal to about 5 vol. % to less than or equal to about 40 vol. %, and in certain aspects, optionally greater than or equal to about 10 vol. % to less than or equal to about 40 vol. %. A battery 20 in green form may have an overall interparticle porosity that is greater than or equal to 5 vol. % to less than or equal to 40 vol. %, and in certain aspects, optionally greater than or equal to 10 vol. % to less than or equal to 40 vol. %. In certain variations, a polymeric gel electrolyte (e.g., a semi-solid electrolyte) may be disposed within a solid-state battery so as to wet interfaces and/or fill void spaces between the solid-state electrolyte particles and/or the solid-state active material particles.

In various aspects, as illustrated in FIG. 1B, a polymeric gel electrolyte system 100 may be disposed within the battery 20 between the solid-state electrolyte particles 30, 90, 92 and/or the solid-state electroactive particles 50, 60, so as to, for example only, reduce interparticle porosity 80, 82, 84 and improve ionic contact and/or enable higher power capability. In certain variations, the battery 20 may include greater than or equal to about 0.5 wt. % to less than or equal to about 50 wt. %, and in certain aspects, optionally greater than or equal to about 5 wt. % to less than or equal to about 35 wt. %, of the polymeric gel electrolyte system 100. The battery 20 may include greater than or equal to 0.5 wt. % to less than or equal to 50 wt. %, and in certain aspects, optionally greater than or equal to 5 wt. % to less than or equal to 35 wt. %, of the polymeric gel electrolyte system 100.

Although it appears that there are no pores or voids remaining in the illustrated figure, the skilled artisan will recognize that some porosity may remain between adjacent particles (including, for example only, between the solid-state electroactive particles 50 and/or the solid-state electrolyte particles 90 and/or the solid-state electrolyte particles 30, and between the solid-state electroactive particles 60 and/or the solid-state electrolyte particles 92 and/or the solid-state electrolyte particles 30) depending on the penetration of the polymeric gel electrolyte system 100. For example, a battery 20 including the polymeric gel electrolyte system 100 may have a porosity less than or equal to about 30 vol. %, and in certain aspects, optionally less than or equal to about 10 vol. %. A battery 20 including the polymeric gel electrolyte system 100 may have a porosity less than or equal to 30 vol. %, and in certain aspects, optionally less than or equal to 10 vol. %.

In various aspects, the polymeric gel electrolyte system 100 includes a polymeric host and a liquid electrolyte. For example, the polymeric gel electrolyte system 100 may include greater than or equal to about 0.1 wt. % to less than or equal to about 50 wt. %, and in certain aspects, optionally greater than or equal to about 0.1 wt. % to less than or equal to about 10 wt. %, of the polymeric host, and greater than or equal to about 5 wt. % to less than or equal to about 99 wt. %, and in certain aspects, optionally greater than or equal to about 50 wt. % to less than or equal to about 95 wt. %, of the liquid electrolyte. The polymeric gel electrolyte system 100 may include greater than or equal to 0.1 wt. % to less than or equal to 50 wt. %, and in certain aspects, optionally greater than or equal to 0.1 wt. % to less than or equal to 10 wt. %, of the polymeric host, and greater than or equal to 5 wt. % to less than or equal to 99 wt. %, and in certain aspects, optionally greater than or equal to 50 wt. % to less than or equal to 95 wt. %, of the liquid electrolyte.

In certain variations, the polymeric host may be selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof.

The liquid electrolyte may include a lithium salt and a solvent. For example, the liquid electrolyte may include greater than or equal to about 5 wt. % to less than or equal to about 70 wt. %, and in certain aspects, optionally greater than or equal to about 10 wt. % to less than or equal to about 50 wt. %, of the lithium salt, and greater than or equal to about 30 wt. % to less than or equal to about 95 wt. %, and in certain aspects, optionally greater than or equal to about 50 wt. % to less than or equal to about 90 wt. %, of the solvent. The liquid electrolyte may include greater than or equal to 5 wt. % to less than or equal to 70 wt. %, and in certain aspects, optionally greater than or equal to 10 wt. % to less than or equal to 50 wt. %, of the lithium salt, and greater than or equal to 30 wt. % to less than or equal to 95 wt. %, and in certain aspects, optionally greater than or equal to 50 wt. % to less than or equal to 90 wt. %, of the solvent.

The lithium salt includes a lithium cation (Li⁺) and at least one anion selected from the group consisting of: hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI) bis(pentafluoroethanesulfonyl)imide (BETI), bis(oxalate)borate (BOB), difluoro(ocalato)borate (DFOB), bis(fluoromalonato)boarate (BFMB), and combinations thereof. For example, in certain variations, the lithium salt may be selected from the group consisting of: lithium hexafluoroarsenate (LiAsF₆), lithium hexafluorophosphate (LiPF₆), lithium bis(fluorosulfonyl)imide (LiFSI), lithium bis(trifluoromethanesulfonyl)imide (LiTFSI), lithium perchlorate (LiClO₄), lithium tetrafluoroborate (LiBF₄), lithium-cyclo-difluoromethane-1,1-bis(sulfonyl)imide (LiDMSI), lithium bis(trifluoromethanesulfonyl)imide (LiTFSI), lithium bis(pentafluoroethanesulfonyl)imide (LiBETI), lithium bis(oxalato)borate (LiBOB), lithium difluoro(oxalato)borate (LiDFOB), lithium bis(monofluoromalonato)borate (LiBFMB), lithium difluorophosphate (LiPO₂F₂), lithium fluoride (LiF), lithium trifluoromethyl sulfonate (LiTFO), lithium difluoro(oxalato)borate (LiDFOB), and combinations thereof.

The solvent dissolves the lithium salt to enable good lithium ion conductivity, while also exhibiting a low vapor pressure (e.g., less than about 10 mmHg at 25° C.) to match the cell fabrication process. In various aspects, the solvent includes, for example, carbonate solvents (such as, ethylene carbonate (EC), propylene carbonate (PC), glycerol carbonate, vinylene carbonate, fluoroethylene carbonate, 1,2-butylene carbonate, and the like), lactones (such as, γ-butyrolactone (GBL), δ-valerolactone, and the like), nitriles (such as, succinonitrile, glutaronitrile, adiponitrile, and the like), sulfones (such as, tetramethylene sulfone, ethyl methyl sulfone, vinyl sulfone, phenyl sulfone, 4-fluorophenyl sulfone, benzyl sulfone, and the like), ethers (such as, triethylene glycol dimethylether (triglyme, G3), tetraethylene glycol dimethylether (tetraglyme, G4), 1,3-dimethyoxy propane, 1,4-dioxane, and the like), phosphates (such as, triethyl phosphate, trimethyl phosphate, and the like), ionic liquids including ionic liquid cations (such as, 1-ethyl-3-methylimidazolium ([Emim]+), 1-propyl-1-methylpiperidinium ([PP₁₃]⁺), 1-butyl-1-methylpiperidinium ([PP₁₄]⁺), 1-methyl-1-ethylpyrrolidinium ([Pyr₁₂]⁺), 1-propyl-1-methylpyrrolidinium ([Pyr₁₃]⁺), 1-butyl-1-methylpyrrolidinium ([Pyr₁₄]⁺), and the like) and ionic liquid anions (such as, bis(trifluoromethanesulfonyl)imide (TFSI), bis(fluorosulfonyl imide (FS), and the like), and combinations thereof.

As discussed above, during discharge, the negative electrode 22 may contain intercalated lithium, which is oxidized into lithium ions and electrons. Lithium ions may travel from the negative electrode 22 to the positive electrode 24, for example, through the ionically conductive electrolyte 30 contained within the pores of an interposed porous separator 26. Concurrently, electrons pass through an external circuit 40 from the negative electrode 22 to the positive electrode 24. Such lithium ions may be assimilated into the material of the positive electrode 22 by an electrochemical reduction reaction. The battery 20 may be recharged or regenerated after a partial or full discharge of its available capacity by an external power source, which reverses the electrochemical reactions that transpired during discharge.

In certain instances, however, a portion of the lithium remains with the negative electrode 22, for example, as a result of conversion reactions and/or the formation of a solid electrolyte interphase (SEI) layer (not shown) on the negative electrode 22 during the first cycle, as well as ongoing lithium loss due to, for example, continuous solid electrolyte interphase (SEI) growth and rebuild. The solid electrolyte interface (SEI) layer can form over the surface of the negative electrode, which is often generated by reaction products of electrolyte reduction, and/or lithium ion reduction. Such permanent loss of lithium ions may result in a decreased specific energy and power in the battery 20. For example, the battery 20 may experience an irreversible capacity loss of greater than or equal to about 5% to less than or equal to about 30% after the first cycle.

Lithiation, for example pre-lithiation of the electroactive materials prior to incorporation into the battery 20, may compensate for such lithium losses during cycling. For example, an amount of lithium prelithiated together with appropriate negative electrode capacity and/or positive electrode capacity ratio (N/P ratio) can be used to improve the cycle stability of the battery 20. The reserved lithium can compensate for lithium lost during cycling, including during the first cycle, so as to decrease capacity loss over time. In various aspects, as illustrated in FIG. 1C, the present disclosure provides a lithium-source or sacrificial coating 38 that substantially surrounds or encompasses each positive solid-state electroactive particle 60 and provides, or serves as, a lithium reservoir in the cell 20.

The sacrificial coating 38 includes lithium-source material or additive having a high theoretical specific capacity. For example, the battery 20 may include greater than or equal to about 0.01 wt. % to less than or equal to about 50 wt. % of the lithium-source material. The lithium-source material may have a theoretical specific capacity greater than or equal to about 100 mAh/g to less than or equal to about 3,000 mAh/g. In certain variations, the lithium-source material may be lithium sulfide having a theoretical specific capacity of about 1167 mAh/g. In other variations, the lithium-source material may include organic lithium salts (e.g., 3,4-dihydroxybenzonitrile dilithium salt (Li₂DHBN)); lithium salt including azides (LiN₃), oxocarbons, dicarboxylates, and/or hydrazides; lithium nitride (Li₃N); lithium nickel oxide (e.g., L_{10.65}Ni_{1.35}O₂); Li₅FeO₄; lithium rhenium oxide (Li₅ReO₆); Li₆CoO₄; and/or Li₃V₂(PO₄)₃. In still other variations, the lithium-source material may include lithium-fluoride and lithium-fluoride metal composites (e.g., LiF/Co and LiF/Fe); Li₂O and Li₂O/metal composite (e.g., Li₂O/Co, Li₂O/Fe and Li₂O/Ni); Li₂S/metal composite (e.g., Li₂S/Co); Li₂CuO₂; Li₂NiO₂; Al₂O₃-coated Li₂NiO₂; other oxides-coated Li₂NiO₂; Li₂MoO₃; and/or other lithium transition-metal oxides. In each variation, the sacrificial coating 38 may cover greater than or equal to about 5 wt. % to less than or equal to about 100 wt. % of a total exposed surface area of each positive solid-state electroactive particle 60. The sacrificial coating 38 may cover greater than or equal to 5 wt. % to less than or equal to 100 wt. % of a total exposed surface area of each positive solid-state electroactive particle 60. The sacrificial coating 38 may have an average thickness of greater than or equal to about 1 nm to less than or equal to about 500 nm. The sacrificial coating 38 may have an average thickness of greater than or equal to 1 nm to less than or equal to 500 nm.

During an initial charging event, for example, to about 4.2 V, lithium ions can be extracted from the sacrificial coating 38 (e.g., Li₂S→2Li⁺+S+2e⁻, 1166 mAh/g) and used to compensate for irreversible active lithium loss in the negative electrode 22. By keeping the battery operation discharge cutoff voltage above about 2.5 V, and in certain variations, above about 3.0 V, the extracted lithium ions are subsequently unable to convert into lithium sulfide (Li₂S) and are therefore form a lithium reservoir.

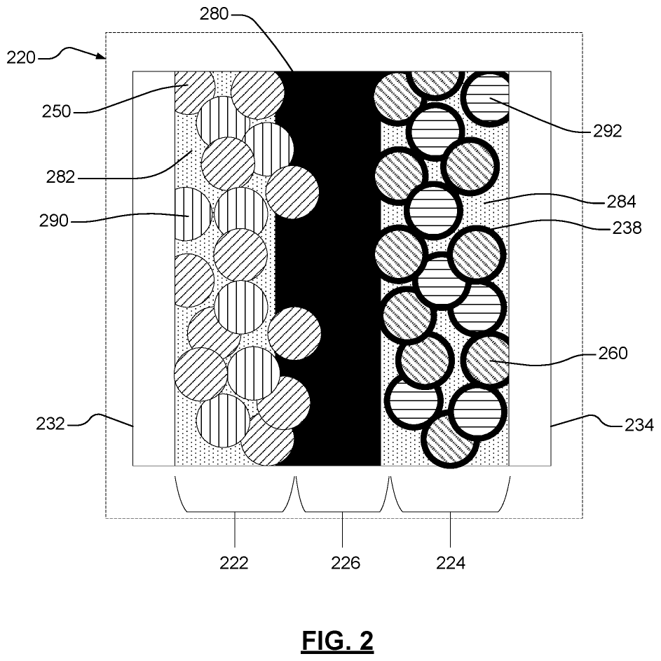

An exemplary and schematic illustration of another solid-state electrochemical cell unit 220 that cycles lithium ions is shown in FIG. 2. Like battery 20 illustrated in FIGS. 1A-1C, the battery 220 includes a negative electrode (i.e., anode) 222, a first current collector 232 positioned at or near a first side of the negative electrode 222, a positive electrode (i.e., cathode) 224, a second current collector 234 positioned at or near a first side of the positive electrode 224, and an electrolyte layer 226 disposed between a second side of the negative electrode 222 and a second side of the positive electrode 224, where the second side of the negative electrode 222 is substantially parallel with the first side of the negative electrode 222 and the second side of the positive electrode 224 is substantially parallel with the first side of the positive electrode 224.

Like the negative electrode 22 illustrated in FIGS. 1A-1C, the negative electrode 222 may include a plurality of negative solid-state electroactive particles 250 mixed with an optional first plurality of solid-state electrolyte particles 290. The negative electrode 222 may further include a first polymeric gel electrolyte system 282 that at least partially fills void spaces between the negative solid-state electroactive particles 250 and/or the optional solid-state electrolyte particles 290.

Like the positive electrode 24 illustrated in FIGS. 1A-1C, the positive electrode 224 may include a plurality of positive solid-state electroactive particles 260 mixed with an optional second plurality of solid-state electrolyte particles 292. The positive electrode 224 may further include a second polymeric gel system 284 that at least partially fills void spaces between the positive solid-state electroactive particles 260 and/or the optional solid-state electrolyte particles 292. The second polymeric gel system 284 may be the same or different from the first polymeric gel system 282. The positive electrode 224 may further include a sacrificial coating 238 that substantially surrounds or encompasses each positive solid-state electroactive particle 260 and provides, or serves as, a lithium reservoir in the cell 20.

The electrolyte layer 226 may be a separating layer that physically separates the negative electrode 222 from the positive electrode 224. The electrolyte layer 226 may be a free-standing membrane 280 defined by a third polymeric gel electrolyte system similar to the polymeric gel electrolyte system illustrated in FIGS. 1A-1C. In certain variations, the free-standing membrane 280 may have a thickness greater than or equal to about 5 μm to less than or equal to about 1,000 μm, and in certain aspects, optionally greater than or equal to about 2 μm to less than or equal to about 50 μm. The free-standing membrane 280 may have a thickness greater than or equal to 5 μm to less than or equal to 1,000 μm, and in certain aspects, optionally greater than or equal to 2 μm to less than or equal to 50 μm.

Although not illustrated, the skilled artisan will recognize that, in certain variations, the negative electrode 222 may be free of a first polymeric gel electrolyte system 282 and/or the positive electrode 224 may be free of a second polymeric gel electrolyte system 284. Similarly, considering the teachings of FIGS. 1A-1C, although not illustrated, the skilled artisan will recognize that, in certain variations, the negative electrode 22, the positive electrode 24, and/or the electrolyte layer 26 may be free of the polymeric gel electrolyte system 100. That is, in the instance of FIG. 1B, one of the negative electrode 22, the positive electrode 24, and/or the electrolyte layer 26 may include polymeric gel electrolyte system 100.

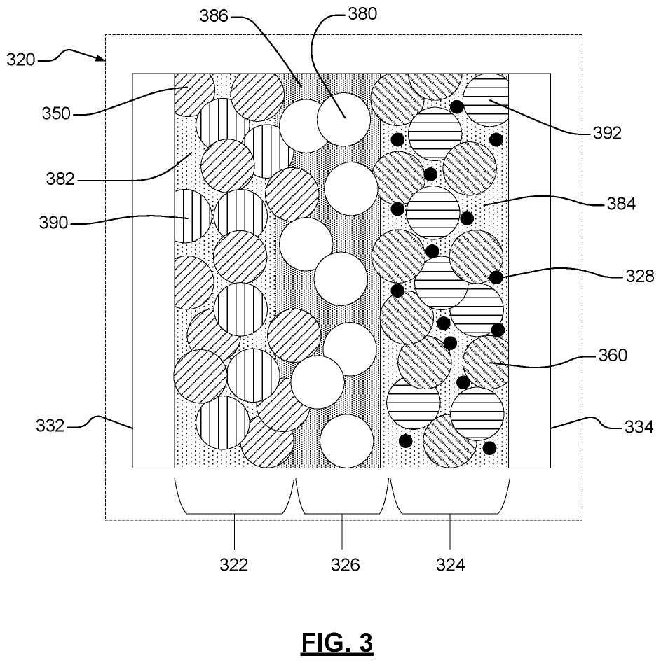

An exemplary and schematic illustration of another solid-state electrochemical cell unit 300 that cycles lithium ions is shown in FIG. 3. Like battery 20 illustrated in FIGS. 1A-1C and/or the battery 220 illustrated in FIG. 2, the battery 320 includes a negative electrode (i.e., anode) 322, a first current collector 332 positioned at or near a first side of the negative electrode 322, a positive electrode (i.e., cathode) 324, a second current collector 334 positioned at or near a first side of the positive electrode 324, and an electrolyte layer 326 disposed between a second side of the negative electrode 322 and a second side of the positive electrode 324, where the second side of the negative electrode 322 is substantially parallel with the first side of the negative electrode 322 and the second side of the positive electrode 324 is substantially parallel with the first side of the positive electrode 324.

Like the negative electrode 22 illustrated in FIGS. 1A-1C, the negative electrode 322 may include a plurality of negative solid-state electroactive particles 350 mixed with an optional first plurality of solid-state electrolyte particles 390. The negative electrode 322 may further include a first polymeric gel electrolyte system 382 that at least partially fills void spaces between the negative solid-state electroactive particles 350 and/or the optional solid-state electrolyte particles 390.

Like the positive electrode 24 illustrated in FIGS. 1A-1C, the positive electrode 324 may include a plurality of positive solid-state electroactive particles 360 mixed with an optional second plurality of solid-state electrolyte particles 392. The positive electrode 324 may further include a second polymeric gel system 384 that at least partially fills void spaces between the positive solid-state electroactive particles 360 and/or the optional solid-state electrolyte particles 392. The second polymeric gel system 384 may be the same or different from the first polymeric gel system 382.

The positive electrode 324 may further include a plurality of lithium-source or sacrificial particles 338 mixed with the plurality of positive solid-state electroactive particles 360 (and the optional second plurality of solid-state electrolyte particles 392). For example, the positive electrode 324 may include greater than or equal to about 0.01 wt. % to less than or equal to about 50 wt. %, and in certain aspects, optionally greater than or equal to about 0.11 wt. % to less than or equal to about 20 wt. %, of the lithium-source particles 338. The positive electrode 324 may include greater than or equal to 0.01 wt. % to less than or equal to 50 wt. %, and in certain aspects, optionally greater than or equal to 0.11 wt. % to less than or equal to 20 wt. %, of the lithium-source particles 338. The lithium-source particles 338 may have an average particle size greater than or equal to about 20 nm to less than or equal to about 20 μm, and in certain aspects, optionally greater than or equal to about 50 nm to less than or equal to about 10 μm. The lithium-source particles 338 may have an average particle size greater than or equal to 20 nm to less than or equal to 20 μm, and in certain aspects, optionally greater than or equal to 50 nm to less than or equal to 10 μm.

The lithium-source particles 338 include a lithium-source material having a high theoretical specific capacity. For example, the lithium-source material may have a theoretical specific capacity greater than or equal to about 100 mAh/g to less than or equal to about 3,000 mAh/g. In certain variations, the lithium-source material may be lithium sulfide having a theoretical specific capacity of about 1167 mAh/g. In other variations, the lithium-source material may include organic lithium salts (e.g., 3,4-dihydroxybenzonitrile dilithium salt (Li₂DHBN)); lithium salt including azides (LiN₃), oxocarbons, dicarboxylates, and/or hydrazides; lithium nitride (Li₃N); lithium nickel oxide (e.g., L_{10.65}Ni_{1.35}O₂); Li₅FeO₄; lithium rhenium oxide (Li₅ReO₆); Li₆CoO₄; and/or Li₃V₂(PO₄)₃. In still other variations, the lithium-source material may include lithium-fluoride and lithium-fluoride metal composites (e.g., LiF/Co and LiF/Fe); Li₂O and Li₂O/metal composite (e.g., Li₂O/Co, Li₂O/Fe and Li₂O/Ni); Li₂S/metal composite (e.g., Li₂S/Co); Li₂CuO₂; Li₂NiO₂; Al₂O₃-coated Li₂NiO₂; other oxides-coated Li₂NiO₂; Li₂MoO₃; and/or other lithium transition-metal oxides.

The electrolyte layer 326 may be a separating layer that physically separates the negative electrode 322 from the positive electrode 324. Similar to the electrolyte layer 26 illustrated in FIGS. 1A-IC, the electrolyte layer 326 may be defined by a third plurality of solid-state electrolyte particles 330. For example, the electrolyte layer 326 may be in the form of a layer or a composite that comprises the third plurality of solid-state electrolyte particles 330. The electrolyte layer 326 may further include a third polymeric gel system 386 that at least partially fills void spaces between the solid-state electrolyte particles 330. The third polymeric gel system 386 may be the same or different from the second polymeric gel system 384.

Although not illustrated, the skilled artisan will appreciate that in various aspects the electrolyte layer 326 may be a free-standing member like the free-standing member 280 illustrated in FIG. 2. Similarly, although not illustrated, the skilled artisan will appreciate that in various aspects, the positive electrode 324 may further include a sacrificial coating around one or more of the positive solid-state electroactive particles 360 of the plurality of positive solid-state electroactive particles 360 in addition to the lithium-source particles 338 dispersed within the positive electrode 324.

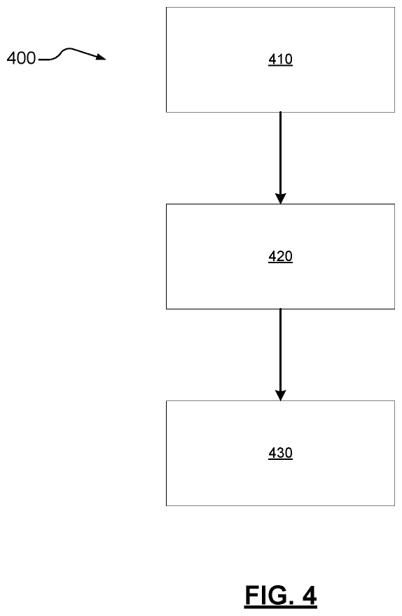

In various aspects, the present disclosure provides methods for fabricating a positive electrode including a gel electrolyte system and a lithium-source material, such as the positive electrode 24 illustrated in FIG. 1C and/or the positive electrode 224 illustrated in FIG. 2 and/or the positive electrode 324 illustrated in FIG. 3. For example, FIG. 4 illustrates an example method 400 for forming a positive electrode. As illustrated, the method 400 includes contacting 420 a cathode precursor and a lithium-source solution. In certain variations, contacting 420 the cathode precursor and the lithium-source solution may include adding the lithium-source solution to the cathode precursor in a drop-wise fashion, such that a capillary force causes the lithium-source solution to impregnate the cathode precursor. For example, the lithium-source solution may enter voids between the positive solid-state electroactive material particles, and the optional solid-state electrolyte particles, that define the cathode precursor. In certain variations, the method 400 may include preparing 410 the cathode precursor. As would be recognized by the skilled artisan, preparing 410 the cathode precursor may include forming a slurry and deposing the slurry on or near one or more surfaces of a current collector. The slurry includes a positive solid-state electroactive material, for example, a plurality of electroactive material particles, and optionally a plurality of solid-state electrolyte particles.

In various aspects, the lithium-source solution includes a lithium-source material having a high theoretical specific capacity. For example, the lithium-source material may have a theoretical specific capacity greater than or equal to about 100 mAh/g to less than or equal to about 3,000 mAh/g. In certain variations, the lithium-source material may be lithium sulfide having a theoretical specific capacity of about 1167 mAh/g. In other variations, the lithium-source material may include organic lithium salts (e.g., 3,4-dihydroxybenzonitrile dilithium salt (Li₂DHBN)); lithium salt including azides (LiN₃), oxocarbons, dicarboxylates, and/or hydrazides; lithium nitride (Li₃N); lithium nickel oxide (e.g., L_{10.65}Ni_{1.35}O₂); Li₅FeO₄; lithium rhenium oxide (Li₅ReO₆); Li₆CoO₄; and/or Li₃V₂(PO₄)₃. In still other variations, the lithium-source material may include lithium-fluoride and lithium-fluoride metal composites (e.g., LiF/Co and LiF/Fe); Li₂O and Li₂O/metal composite (e.g., Li₂O/Co, Li₂O/Fe and Li₂O/Ni); Li₂S/metal composite (e.g., Li₂S/Co); Li₂CuO₂; Li₂NiO₂; Al₂O₃-coated Li₂NiO₂; other oxides-coated Li₂NiO₂; Li₂MoO₃; and/or other lithium transition-metal oxides.

The lithium-source solution further includes one or more solvents. The one or more solvents may be selected from the group consisting of: ethanol, tetrahydrofuran, ethyl propionate, ethylacetate, acetonitrile, water, N-methyl formamide, methanol, 1,2-dimethoxyethane, and combinations thereof. In various aspects, after contacting 420 the cathode precursor and the lithium-source solution, the method 400 may further include removing the solvent. In certain variations, the method 400 may further include removing 430 the solvent. For example, the solvent may be removed by heating the cathode to a temperature greater than or equal to about 50° C. to less than or equal to about 200° C., and in certain aspects, optionally about 150° C., for a period greater than or equal to about 0.5 hours to less than or equal to about 48 hours, and in certain aspects, optionally about 3 hours. The solvent may be removed by heating the cathode to a temperature greater than or equal to 50° C. to less than or equal to 200° C., and in certain aspects, optionally 150° C., for a period greater than or equal to 0.5 hours to less than or equal to 48 hours, and in certain aspects, optionally 3 hours.

In various aspects, the present disclosure provides methods for fabricating a battery, like the battery 20 illustrated in FIG. 1C. The methods may include preparing a positive electrode including a lithium-source material, for example, using method 400 as illustrated in FIG. 4. The method may further include contacting a first polymeric gel electrolyte precursor liquid with the positive electrode. In such instances, the method further includes drying or reacting (e.g., cross-linking) the first precursor liquid to form a gel-assisted first or positive electrode that includes a first polymeric gel electrolyte. For example, the positive electrode may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour, to form the gel-assisted positive electrode that includes a lithium-source material. The positive electrode may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour, to form the gel-assisted positive electrode that includes a lithium-source material.

In certain variations, the method may further include aligning the gel-assisted positive electrode with an electrolyte layer and/or a second or negative electrode. As detailed above, the electrolyte layer may include a second plurality of solid-state electrolyte particles and a second polymeric gel electrolyte. In certain variations, the electrolyte layer may be a gel-assisted electrolyte layer. The gel-assisted electrolyte layer may be prepared by contacting a second polymeric gel electrolyte precursor liquid with a precursor electrolyte layer and drying or reacting (e.g., cross-linking) the second precursor liquid to form the gel-assisted electrolyte layer that includes a second polymeric gel electrolyte. For example, the precursor electrolyte layer including the second precursor liquid may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour, to form the gel-assisted electrolyte layer. The precursor electrolyte layer including the second precursor liquid may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour, to form the gel-assisted electrolyte layer.

The second or negative electrode may include a negative solid-state electroactive material, for example, a plurality of negative solid-state electroactive material particles, and optionally, a third plurality of solid-state electrolyte particles. In certain variations, the negative electrode may be a gel-assisted negative electrode. The gel-assisted negative electrode may be prepared by contacting a third polymeric gel electrolyte precursor liquid with an anode precursor and drying or reacting (e.g., cross-linking) the third precursor liquid to form the gel-assisted negative electrode. For example, the precursor negative electrode including the third precursor liquid may be heated to a temperature greater than or equal to about 10° C. to less than or equal to about 200° C., and in certain aspects, optionally about 25° C., for a period greater than or equal to about 0.1 hours to less than or equal to about 48 hours, and in certain aspects, optionally about 1 hour to form the gel-assisted negative electrode. The precursor negative electrode including the third precursor liquid may be heated to a temperature greater than or equal to 10° C. to less than or equal to 200° C., and in certain aspects, optionally 25° C., for a period greater than or equal to 0.1 hours to less than or equal to 48 hours, and in certain aspects, optionally 1 hour to form the gel-assisted negative electrode.

The third precursor liquid may be the same as or different form the second precursor liquid, and the second precursor liquid may be the same as or different from the first precursor liquid. Similarly, the first plurality of solid-state electrolyte particles may be the same as or different from the second plurality of solid-state electrolyte particles, and the second plurality of solid-state electrolyte particles may be the same as or different from the first plurality of solid-state electrolyte particles.

In various aspects, the present disclosure provides yet further methods for fabricating a battery, like the battery 20 illustrated in FIG. 1C. The method may include preparing a first or positive electrode including a lithium-source material, for example, using method 400 as illustrated in FIG. 4. The methods may further include aligning the positive electrode with an electrolyte layer and/or a second or negative electrode to form a cell. In such instances, a polymeric gel precursor may be added to the assembled cell and subsequently dried or reacted (e.g., cross-linking) to form the gel-assisted electrolyte system. In certain variations, the method may further include preparing the electrolyte layer and/or the negative electrode.

Certain features of the current technology are further illustrated in the following non-limiting examples.

### Example 1

Example battery cells may be prepared in accordance with various aspects of the present disclosure. For example, an example battery cell 510 may include a lithium-source material—for example, a lithium-source or sacrificial coating as illustrated in FIG. 1C and/or FIG. 2, and/or a lithium-source or sacrificial particle as illustrated in FIG. 3, and/or a combination thereof—and a polymeric gel electrolyte system, like that illustrated in FIG. 1C and/or FIG. 2 and/or FIG. 3. A comparative battery cell 520 may include a polymeric gel electrolyte system similar to the example battery cell 510, but excludes a lithium-source material.

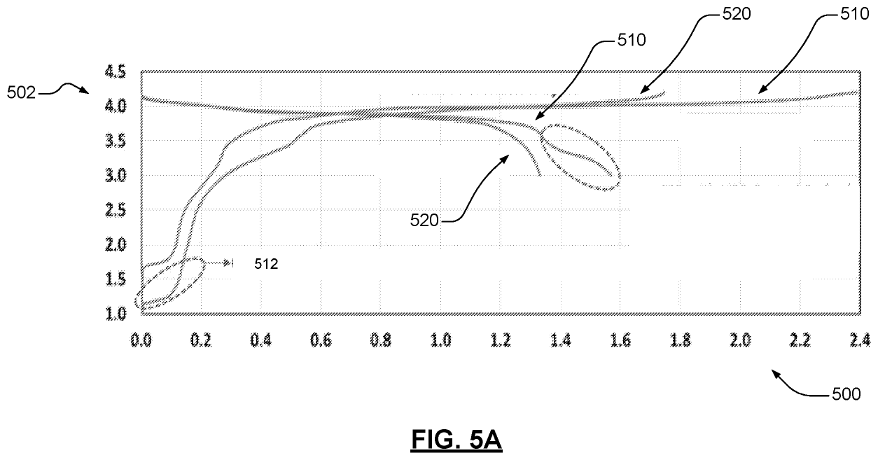

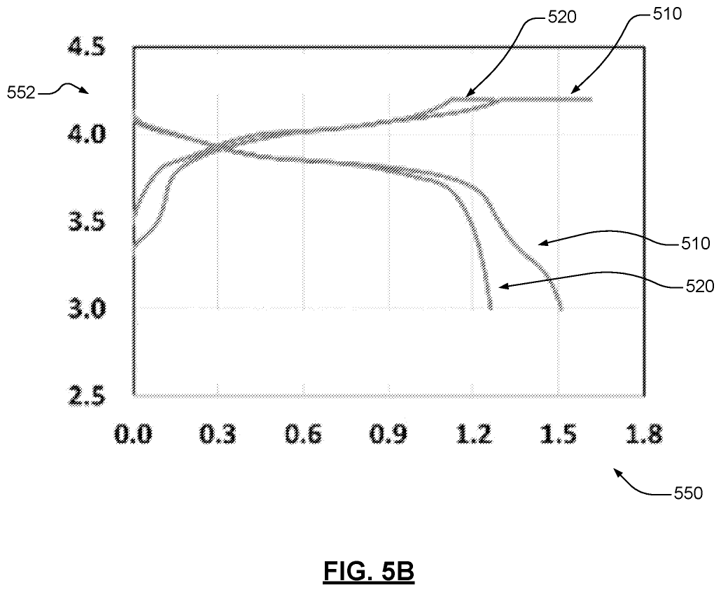

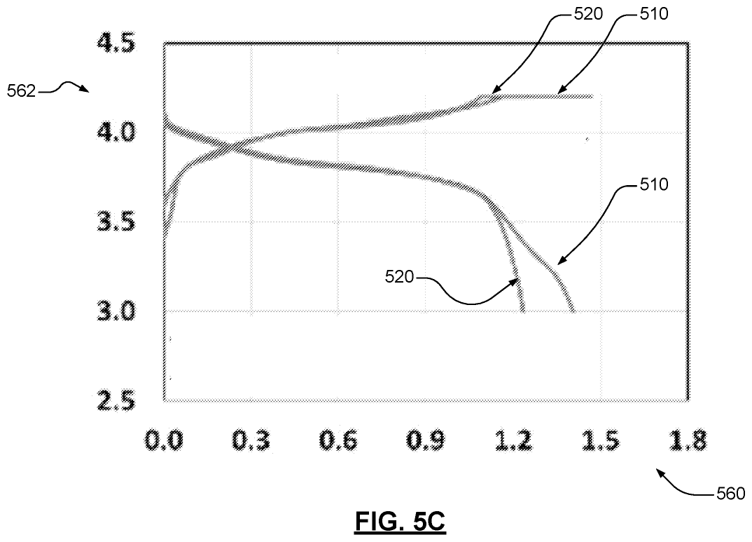

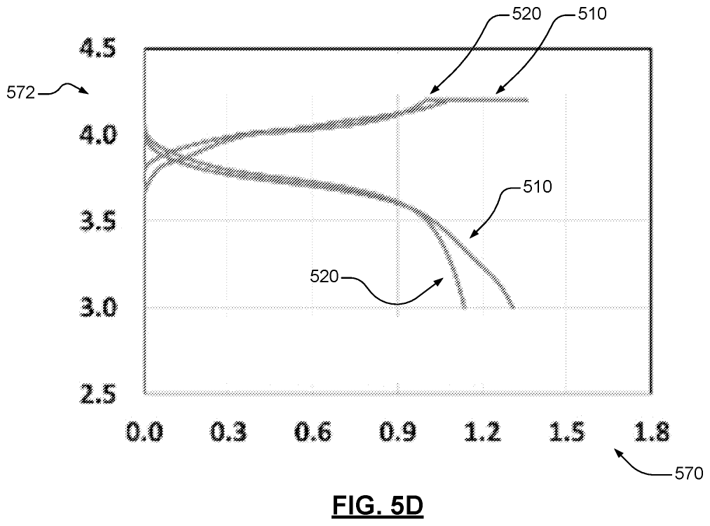

FIG. 5A is a graphical illustration representing the electrochemical performance of the example battery cell 510 and the comparative battery cell 520 during an initial formation cycle at 25° C., where the x-axis 500 represents capacity (mAh) and the y-axis 502 represents voltage (V). As illustrated, the example battery cell 510 prepared in accordance with various aspects of the present disclosure has improved performance and capacity. Notably, the charge plateau 512 at about 1.2 V illustrates the initial lithium ion extraction from the lithium-source material.

FIG. 5B is a graphical illustration representing the electrochemical performance of the example battery cell 510 and the comparative battery cell 520 during the first cycle at 25° C. following the initial formation cycle, where the x-axis 550 represents capacity (mAh) and the y-axis 552 represents voltage (V). As illustrated, the example battery cell 510 prepared in accordance with various aspects of the present disclosure has improved performance and capacity.

FIG. 5C is a graphical illustration representing the electrochemical performance of the example battery cell 510 and the comparative battery cell 520 during the second cycle at 25° C. following the initial formation cycle, where the x-axis 560 represents capacity (mAh) and the y-axis 562 represents voltage (V). As illustrated, the example battery cell 510 prepared in accordance with various aspects of the present disclosure has improved performance and capacity.

FIG. 5D is a graphical illustration representing the electrochemical performance of the example battery cell 510 and the comparative battery cell 520 during the second cycle at 25° C. following the initial formation cycle, where the x-axis 570 represents capacity (mAh) and the y-axis 572 represents voltage (V). As illustrated, the example battery cell 510 prepared in accordance with various aspects of the present disclosure has improved performance and capacity.

In each of FIGS. 5B-5D, the discharge plateau 514 at about 3.3V illustrates enhanced lithium storage within the negative electrode, for example a graphite-containing anode.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A positive electrode comprising:
an active layer comprising:
a plurality of positive electroactive solid-state particles;
a lithium-source material coated on or dispersed with the positive electroactive solid-state particles in the active layer, wherein the lithium-source material has a theoretical specific capacity greater than or equal to about 100 mAh/g to less than or equal to about 3,000 mAh/g; and
a polymeric gel electrolyte at least partially filling voids between the positive electroactive solid-state particles in the active layer.

2. The positive electrode of claim 1, wherein the lithium-source material comprises lithium sulfide (Li₂S).

3. The positive electrode of claim 1, wherein the lithium-source material is selected from the group consisting of: lithium sulfide (Li₂S), 3,4-dihydroxybenzonitrile dilithium salt (Li₂DHBN), LiN₃, Li₃N, Li_{0.65}Ni_{1.35}O₂, Li₅FeO₄, Li₅ReO₆, Li₆CoO₄, Li₃V₂(PO₄)₃, lithium fluoride (LiF), Li₂O, Li₂S/Co, Li₂CuO₂, Li₂NiO₂, Li₂MoO₃, and combinations thereof.

4. The positive electrode of claim 1, wherein the positive electrode comprises greater than or equal to about 0.01 wt. % to less than or equal to about 50 wt. % of the lithium-source material.

5. The positive electrode of claim 1, wherein the lithium-source material is coated on the positive electroactive solid-state particles, wherein the lithium-source material covers greater than or equal to about 5 vol. % to less than or equal to about 100 vol. % of a total exposed surface area of at least one positive electroactive solid-state particle of the plurality of positive electroactive solid-state particles.

6. The positive electrode of claim 1, wherein the lithium-source material coating has an average thickness of greater than or equal to about 1 nm to less than or equal to about 500 nm.

7. The positive electrode of claim 1, wherein the lithium-source material defines a plurality of lithium-source particles that are dispersed with the positive electroactive solid-state particles in the active layer.

8. The positive electrode of claim 7, wherein the lithium-source particles have an average particle size greater than or equal to about 20 nm to less than or equal to about 20 μm.

9. The positive electrode of claim 1, wherein the polymeric gel electrolyte comprises:
greater than or equal to about 0.1 wt. % to less than or equal to about 50 wt. % of a polymeric host selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof; and
greater than or equal to about 5 wt. % to less than or equal to about 90 wt. % of a liquid electrolyte comprising at least one anion selected from the group consisting of: hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI) bis(pentafluoroethanesulfonyl)imide (BETI), bis(oxalate)borate (BOB), difluoro(ocalato)borate (DFOB), bis(fluoromalonato)boarate (BFMB), and combinations thereof.

10. The positive electrode of claim 1, further comprising:
a plurality of solid-state electrolyte particles dispersed with the positive electroactive solid-state particles.

11. An electrochemical cell that cycles lithium ions, the electrochemical cell comprising:
an electrode comprising:
a plurality of electroactive solid-state particles;
a lithium-source material coated on or dispersed with the electroactive solid-state particles in the electrode, wherein the lithium-source material has a theoretical specific capacity greater than or equal to about 100 mAh/g to less than or equal to about 3,000 mAh/g; and
a polymeric gel electrolyte at least partially filling voids between the electroactive solid-state particles.

12. The electrochemical cell of claim 11, wherein the lithium-source material is selected from the group consisting of: lithium sulfide (Li₂S), 3,4-dihydroxybenzonitrile dilithium salt (Li₂DHBN), LiN₃, Li₃N, Li_{0.65}Ni_{1.35}O₂, Li₅FeO₄, Li₅ReO₆, Li₆CoO₄, Li₃V₂(PO₄)₃, lithium fluoride (LiF), Li₂O, Li₂S/Co, Li₂CuO₂, Li₂NiO₂, Li₂MoO₃, and combinations thereof.

13. The electrochemical cell of claim 11, wherein the electrode comprises greater than or equal to about 0.01 wt. % to less than or equal to about 50 wt. % of the lithium-source material.

14. The electrochemical cell of claim 11, wherein the lithium-source material is coated on the electroactive solid-state particles,
the lithium-source material covers greater than or equal to about 5 vol. % to less than or equal to about 100 vol. % of a total exposed surface area of at least one electroactive solid-state particle of the plurality of electroactive solid-state particles, and
the lithium-source material coating has an average thickness of greater than or equal to about 1 nm to less than or equal to about 500 nm.

15. The electrochemical cell of claim 11, wherein the lithium-source material defines a plurality of lithium-source particles that are dispersed with the electroactive solid-state particles, and
the lithium-source particles have an average particle size greater than or equal to about 20 nm to less than or equal to about 20 μm.

16. The electrochemical cell of claim 11, wherein the electrode is a first electrode, the plurality of electroactive solid-state particles is a plurality of first electroactive solid-state particles, and the polymeric gel electrolyte is a first polymeric gel electrolyte, and the electrochemical cell further comprises:
a second electrode comprising a plurality of second electroactive solid-state particles and a second polymeric gel electrolyte; and
an electrolyte layer disposed between the first electrode and the second electrode comprising a third polymeric gel electrolyte.

17. The electrochemical cell of claim 16, wherein the first polymeric gel electrolyte, the second polymeric gel electrolyte, and the third polymeric gel electrolyte each comprises:
a polymeric host independently selected from the group consisting of: polyvinylidene fluoride (PVDF), polyvinylidene fluoride-hexafluoropropylene (PVDF-HFP), polyethylene oxide (PEO), polypropylene oxide (PPO), polyacrylonitrile (PAN), polymethacrylonitrile (PMAN), polymethyl methacrylate (PMMA), carboxymethyl cellulose (CMC), poly(vinyl alcohol) (PVA), polyvinylpyrrolidone (PVP), and combinations thereof;
a lithium salt comprising at least one anion independently selected from hexafluoroarsenate, hexafluorophosphate, bis(fluorosulfonyl)imide (FSI), perchlorate, tetrafluoroborate, cyclo-difluoromethane-1,1-bis(dulfonyl)imide (DMSI), bis(trifluoromethanesulfonyl)imide (TFSI) bis(pentafluoroethanesulfonyl)imide (BETI), bis(oxalate)borate (BOB), difluoro(ocalato)borate (DFOB), bis(fluoromalonato)boarate (BFMB), and combinations thereof; and
a solvent independently selected from the group consisting of: ethylene carbonate (EC), propylene carbonate (PC), glycerol carbonate, vinylene carbonate, fluoroethylene carbonate, 1,2-butylene carbonate, γ-butyrolactone (GBL), 6-valerolactone, succinonitrile, glutaronitrile, adiponitrile, tetramethylene sulfone, ethyl methyl sulfone, vinyl sulfone, phenyl sulfone, 4 fluorophenyl sulfone, benzyl sulfone, triethylene glycol dimethylether (triglyme, G3), tetraethylene glycol dimethylether (tetraglyme, G4), 1,3-dimethyoxy propane, 1,4-dioxane, triethyl phosphate, trimethyl phosphate, 1-ethyl-3-methylimidazolium ([Emim]+), 1-propyl-1-methylpiperidinium ([PP₁₃]+), 1-butyl-1-methylpiperidinium ([PP₁₄]+), 1-methyl-1-ethylpyrrolidinium ([Pyr₁₂]+), 1-propyl-1-methylpyrrolidinium ([Pyr₁₃]+), 1-butyl-1-methylpyrrolidinium ([Pyr₁₄]+), bis(trifluoromethanesulfonyl)imide (TFSI), bis(fluorosulfonyl imide (FS), and combinations thereof.

18. The electrochemical cell of claim 16, wherein the electrolyte layer further comprises:
a plurality of solid-state electrolyte particles.

19. The electrochemical cell of claim 16, wherein the electrolyte layer is a free-standing membrane.

20. A positive electrode comprising:
a plurality of positive electroactive solid-state particles;
a lithium-source material coated on at least one positive electroactive solid-state particle of the plurality of positive electroactive solid-state particles, wherein the lithium-source material comprises lithium sulfide (Li₂S) and the lithium-source material covers greater than or equal to about 5 vol. % to less than or equal to about 100 vol. % of a total exposed surface area of the at least one positive electroactive solid-state; and
a polymeric gel electrolyte at least partially filling voids between the positive electroactive solid-state particles.
